(19) United States
(12) Patent Application Publication
(10) Pub. No.: US 2014/0050410 A1
(43) Pub. Date: Feb. 20, 2014

(54) METHOD AND DEVICE FOR DETERMINING THE TORSIONAL COMPONENT OF THE EYE POSITION

(71) Applicant: Kai Just, Bonn (DE)

(72) Inventor: Kai Just, Bonn (DE)

(73) Assignee: CHRONOS VISION GMBH, Berlin (DE)

(21) Appl. No.: 13/992,992

(22) PCT Filed: Dec. 4, 2011
(86) PCT No.: PCT/DE2011/002059

§ 371 Date: Oct. 26, 2013

(30) Foreign Application Priority Data
Dec. 12, 2010 (DE) 10 2010 054 168.0

(51) Int. Cl. G06K 9/46

(52) U.S. Cl. CPC G06K 9/46
USPC 382/197

(57) ABSTRACT

A method for determining the torsional component of an eye around the viewing direction comprises the steps: Recording an image of the eye (110); Extracting at least one “region of interest” (120) and transformation into a polar coordinate image (130); Detecting objects of at least one predefined object type in the polar coordinate image (140); Generating a function of the respective object type depending on the polar coordinate angle Phi (150); Generating a code from the functions of the object types depending on the polar coordinate angle Phi (160); and comparing the code (30) with a code being determined from a previous recording (170). The function of each object type is a 1-dimensional function, which is generated by combining (e.g. summarizing) along the radial component. A device for determining a measure of the torsional position of the eye position is designed for performing the method.

The present invention relates to a method and a device for determining the torsional movement of the human eye.

The position of the eye is governed by three pairs of muscles, which characterize a rotation of the eyeball around a horizontal, vertical and torsional axis. During the torsional movement, the eye rotates actually around the viewing axis. To determine this torsional component is complex in view of image processing and there exist numerous algorithms trying to determine this rotational movement.

The determination of the torsional position of the human eye is important in the field of medical engineering and in neurologic diagnostics. In medical engineering, for example for the insertion of toric intraocular lenses, a rotation of the eye must be exactly known in order to assure the exact adjustment of the lens relative to the eye. Further, for laser surgery or the preparation thereof, the knowledge of the torsional component of the eye position leads to a more precise result. Further possible fields of applications are the research of the brain functions or the investigation of the effect of images or in general visual stimuli on the human being, for example in the fields of advertisement and communication.

Here it needs to be considered that the torsional component may change in a relatively short period of time, so that a current information about the torsional position of the eye is very important.

Another field which is close to the subject of eye torsion is the field of iris recognition. Here, the objective is to use the human iris exactly like a finger print in order to identify persons clearly without ambiguity. The human iris shows very individual patterns, which can be assigned unambiguously to a person, similar to a finger print. Further individual patterns, as for example blood vessels, may exist on the sclera.

In the document WO02/071316A1 an iris recognition method is described, which has the objective to correct an iris image which has been rotated due to a viewing direction which is not aligned with the camera axis. Here, an image is recorded and the inner and outer limits of the iris are identified with an edge detector or canny edge detector. Then, iris patterns are included which are only in predefined distances to the inner boundary area. Thereafter, the iris image is transformed into polar coordinates.

The document KR1020030051963A shows a method for detecting an iris rotation in an iris recognition system. By this, the time for comparing an iris code during iris recognition shall be reduced. For this purpose, an image of the eye is recorded with the iris recognition system by a camera. From the image, a gradient of the iris is detected. The image is rotated corresponding to the gradient and the gradient is corrected. According to the described method, an iris code of the gradient corrected iris is generated and registered in an iris algorithm.

It is the object of the present invention to provide a method and a device by which the torsional component of the eye position can be determined.

The objective is achieved by the method for determining the torsional component of the eye position according to claim 1, by the device for determining the torsional component of an eye position according to claim 8, and by the program according to claim 9, Further advantageous features and details will become apparent from the dependent claims, the description and the drawings.

The invention is based on the idea to detect individual patterns of the eye, and with the help of these patterns to determine the torsional component of the current eye position or eye movement. These patterns can be natural patterns, which are e.g. searched within the iris. Individual patterns (like e.g. blood vessels) may also be searched on the sclera or on the retina. Further, it is also possible with this method, to include artificial markers on the eye. The basic idea of the invention is to detect patterns of predefined object types in the region of the eye in a polar coordinate system, to generate for each object type a function which is depending of the angle Phi of the polar coordinate system, and to generate from the functions of the object types an individual code which is compared with a code being generated from a previous image, in order to determine therefrom the torsional component of the eye position.

The inventive method for determining the torsional component of the eye position comprises the steps: Recording an image of the eye; extracting defined search areas or regions of interest (ROI) from the image and transformation in a polar coordinate image; detection of objects of at least one predefined object type in the polar coordinate image; generating a function of the respective object type depending on the polar coordinate angle Phi; generating a code from the functions of the object types depending on the polar coordinate angle Phi; and comparing the code with a code being determined from a previous recording.

By the method of the invention, the individual patterns of the eye are detected, extracted, summarized along their radial component in the polar coordinate image and encoded, thus enabling to detect the torsional component by comparisons with previous images. Thus it is possible to determine relatively fast and with a high accurateness the torsional position or torsional movements of the eye. It is not necessary to place markers on the eye, but it is also possible to perform the method by means of artificial markers on the eye.

Preferably a gradient image is generated from the image in polar coordinates. Thus, object types like corners, edges, etc. in the image can be detected very exactly and quickly. But also other methods for the extraction of objects can be used.

The function of the related object type is preferably generated by combining (e.g. simple addition, weighed addition, etc.) the objects belonging to the object type along the radial coordinate in the polar coordinate image. By this, for each detected object type a particularly exact, characteristic function is resulting only depending on the angular coordinate Phi. Due to the combination along the radial coordinates, a 1-dimensional function is received for each object type.

Preferably, the respective one-dimensional functions of several object types are combined in one single code. In this way, the accurateness is still further increased, since the location information of very many objects of different object types contained in the image are comprised by the code.

The object types are preferably searched by edges, corners, blobs and/or particular texture patterns etc. in the original polar coordinate picture and/or in the related gradient image. Thereby e.g. edges can preferably be detected in a manner that they show predefined directions in their position.

Advantageously, the edges comprise several categories like e.g. vertical or almost vertical edges, horizontal or almost horizontal edges, exact or nearly 45 degrees positive edges, exact or nearly 45 degrees negative edges. The classification can also be made substantially more fine or more rough.

In particular, during comparison of the codes via suitable correlation methods, the maximum of accordance of both codes will be detected.

According to an aspect of the invention, a device for determining the torsional component of the eye position is provided, comprising an apparatus for recording an image of the human eye and an image processing unit for determining a torsional movement of the eye from the recorded image, the image processing unit being designed for performing the method of the invention.

According to a further aspect of the invention, a program for determining the torsional component of the eye position from an image of the eye is provided, the program comprising a program code which causes a further processing of the image from the image processing unit. In particular, the program can be used by different processing units, like e.g. computer, FPGA, DSP, etc., in order to determine the torsion.

Particularly, the program is stored in an internal memory or on a data medium of the processing unit.

Advantages and features which are shown in relation to the method of the invention also apply for the device of the invention, and vice versa.

The invention is exemplary described in the following with reference to the drawings, in which

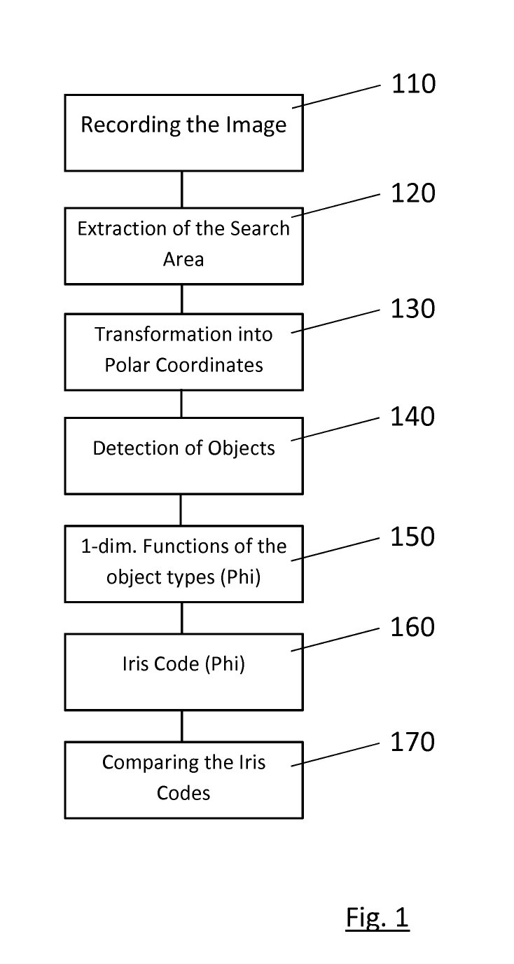

FIG. 1 shows a flowchart which describes the course of actions of the method of the invention according to a preferred embodiment;

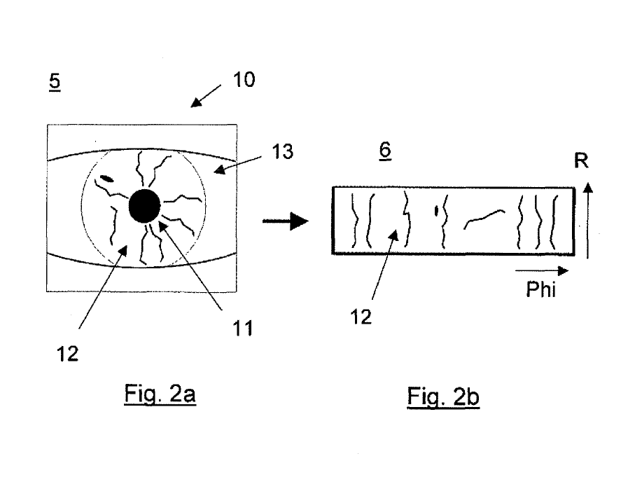

FIG. 2a shows the image of a human eye with pupil and limbus as a schematic diagram;

FIG. 2b shows an image of the iris which is extracted from FIG. 2a as a polar coordinate picture;

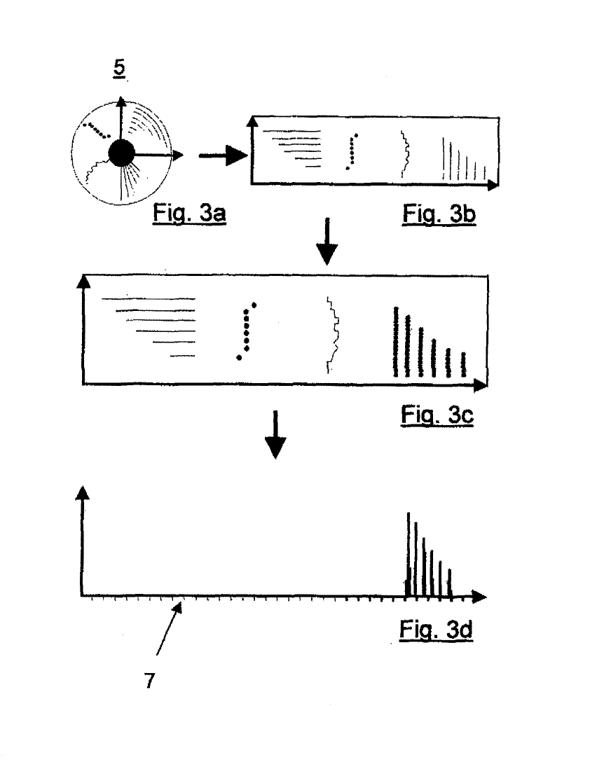

FIG. 3a-c show a schematic diagram of an iris extraction from an image as well as the detection of objects of a specific object type in different stages of the method of the invention;

FIG. 3d shows a 1-dimensional function of a detected object type in the image of FIG. 3c depending on the polar coordinate angle Phi, which function has been generated by an ordinary summation along the radial component;

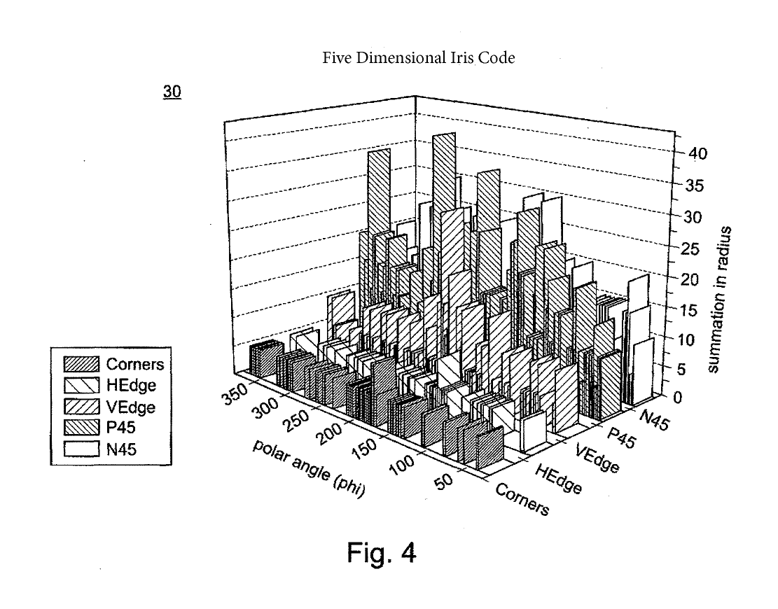

FIG. 4 shows an example of a code created according to the present invention; and

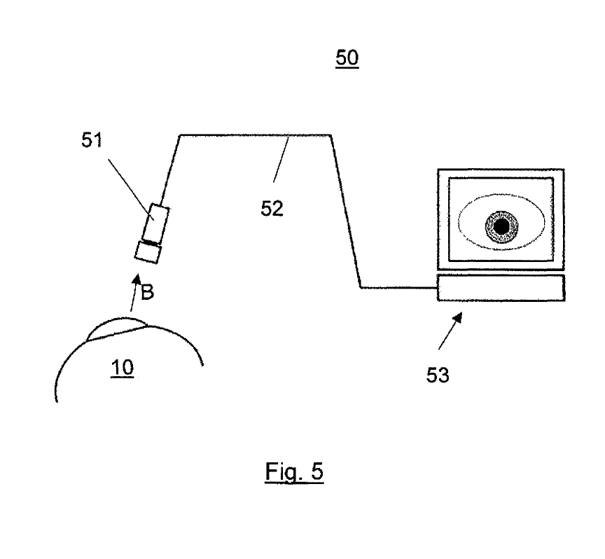

FIG. 5 shows an apparatus according to a preferred embodiment of the invention as a schematic diagram.

The process according to the method of the invention according to a preferred exemplary embodiment will be explained with reference to FIG. 1. Here, reference to the following figures is also made.

In the first step 110, an image 5 of an eye 10 is recorded with an image processing unit (see FIG. 2a). In the center of the eye 10 the pupil 11 is located. The pupil 11 is surrounded by the iris 12. Outside the iris 12 the sclera 13 is located.

In the next step 120 the extraction of the search area or the region of interest (ROI) from the image 5 is carried out. In the present example, the search area is formed by the iris 12. But it is also possible to select other areas in the same way, like for example the sclera 13 or areas thereof. In doing so, the pupil 11 or the edge of the pupil 11 is detected at first, as the edge of the pupil is the natural boundary of the iris. Further, the limbus is detected, i.e. the transition from the iris 12 to the sclera 13 or the “white” of the eye. This edge formed by the limbus represents the natural boundary of the iris 12. The detection of the several areas in image 5 is carried out by the usual methods of image processing. By means of the both boundaries, the information contained in the image is extracted (see FIG. 2a). With the help of simple methods (e.g. distance to the center of the pupil), search areas in the sclera can be extracted as well.

Now in step 130, a transformation of the image in polar coordinates R, Phi is performed, that is, the image is unrolled to a polar coordinate image 6 (see FIG. 2b).

Now in step 140, patterns contained in polar coordinates are detected (see FIG. 3). The FIGS. 3a and 3b show schematically and in a principle presentation an image 5 of the eye 10 (FIG. 3a) as well as the image of the extracted iris 12 (FIG. 3b), which image has been transformed into polar coordinates R, Phi. For a better demonstration of the patterns and of the different kinds of object types, the image 5 represents an artificial model. Then, a gradient image is created from the 2-dimensional polar coordinate image according to FIG. 3b. For this purpose e.g. sobel filters or operators are used. A threshold is arranged and all edges above this gradient threshold will be determined. All edges which have been found will be divided into categories or object types. In the example shown here, the edges are divided into the following four categories: a) vertical edges, b) horizontal edges, c) 45 degrees positive edges, d) 45 degrees negative edges. But also other directions of the edges can be selected.

Further, all corners in the picture are additionally detected by a conventional corner detector. Thus, in the present example a total of five object types are obtained in the 2-dimensional polar coordinate image.

In step 150, the objects of the respective object types are added up along the radial coordinate R, so that for each object type a one dimensional function 7 is generated across the angle Phi. FIG. 3d shows as an example the one dimensional function 7 for the object type “vertical edge”, which is obtained by adding up along the radial component of all vertical edges found in the gradient image 3c from the polar coordinate image according to FIG. 3b.

In the next method step 160, the one dimensional functions of the different object types are combined or summarized in a code 30, which is an iris code in the present example. This is shown in FIG. 4. In the present example a code of five object types is obtained. For each object type, the sum across the radius in the polar coordinate system (y-axis in FIG. 4) compared to the angle Phi in the polar coordinate system (x-axis in FIG. 4) in code 30 is shown.

Different from the example shown here, it is also possible to summarize another number of object types in code 30. The code 30 can also consist of only one object type in an extreme case.

FIG. 5 shows a device 50 for determining the torsion of an eye 10. The device 50 comprises an image recording device 51, which is connected via a data link 52 to an image processing unit 53. The image processing unit 53 is for example realized in a computer by a processor unit and designed in a way that it performs during operation the method steps described above with the image recording unit 51. For this purpose, a control program is provided, which is implemented in the image processing unit 53 and which controls it accordingly.

1. A method for determining the torsional component of an eye position, comprising the steps:
Recording an image of the eye;
Extracting at least one “region of interest” and transformation into a polar coordinate image;
Detecting objects of at least one predefined object type in the polar coordinate image;
Generating a function of the respective object type depending on the polar coordinate angle Phi;
Generating a code from the functions of the object types depending on the polar coordinate angle Phi; and
Comparing the code with a code being determined from a previous recording.

2. The method of claim 1, characterized in that the function of the respective object type is generated by combining the objects belonging to the object type along the radial component in the polar coordinate image.

3. The method of claim 1, characterized in that the functions of a plurality of object types are combined into one single code which is used as a basis for comparison.

4. The method of claim 1, characterized in that the function of the respective object type is a one dimensional function.

5. The method of claim 1, characterized in that the object types comprise one or more edges and/or corners and/or blobs and or texture patterns or other demonstrative patterns in the polar coordinate image of the region of interest.

6. The method of claim 5, characterized in that when involving edges in the polar coordinate image of the region of interest, the edges are detected in a way that they have predefined directions in their position.

7. The method of claim 1, characterized in that during comparison of the codes by a correlation method the maximum of accordance of both codes is determined.

8. A device for determining the torsional component of an eye position, comprising
an apparatus for recording an image of the human eye;
and an image processing unit for determining a torsion or torsional movement of the eye from the recorded image;
characterized in that the image processing unit is designed for performing the method of claim 1.

9. A program for determining the torsional component of an eye position from a region of interest of an image, the program comprising a program code which causes an image processing unit to carry out the method of claim 1.
